(19) United States
(12) Patent Application Publication
(10) Pub. No.: US 2017/0178163 A1
(43) Pub. Date: Jun. 22, 2017

(54) METHOD AND SYSTEM FOR GENERATING A SPLIT QUESTIONNAIRE

(71) Applicant: b3Intelligence Ltd., North York (CA)

(72) Inventors: Walter J. RAMDEHOLL, North York (CA); Harvir S. BANSAL, North York (CA); Avik HALDER, North York (CA); Don SINHA, North York (CA)

(21) Appl. No.: 15/383,698

(22) Filed: Dec. 19, 2016

Related U.S. Application Data
(60) Provisional application No. 62/268,948, filed on Dec. 17, 2015.

(51) Int. Cl. G06Q 30/02

(52) U.S. Cl. CPC G06Q 30/0203

(57) ABSTRACT

A computing system for transforming at least one large questionnaire into a plurality of split questionnaires, said system comprising: one or more processors; memory; a display, and one or more programs stored in the memory and configured to be executed by said one or more processors; a questionnaire database for storing survey pilot data and tracking data associated with said at least one large questionnaire having survey questions; a data conversion module comprising said one or more programs executable to generate a data matrix associated with said survey pilot data and tracking data, and to convert said data matrix into a continuous data matrix; a split-questionnaire design (SQD) module comprising said one or more programs executable to receive said continuous data matrix, and operating to transform said at least one large questionnaire into said plurality of split questionnaires, wherein each of said plurality of split questionnaires comprises a subset of said survey questions; a skip logic module comprising said one or more programs executable to apply conditional logic to the operation of said SQD module when at least one question is based on a respondent's at least one preceding answer to a preceding question; an imputation module comprising said one or more programs executable to impute missing data induced by said SQD module and to create a complete data set; and a reporting module comprising said one or more programs executable to present said split questionnaires on said display.

### CROSS-REFERENCE TO RELATED APPLICATIONS

This application claims the benefit of priority to U.S. Provisional Application Ser. No. 62/268,948, filed on Dec. 17, 2015.

### FIELD OF INVENTION

The present invention relates to large-scale surveys, more particularly it relates to splitting long questionnaires into smaller parts, and integrating skip logic, if present in the surveys.

### BACKGROUND

Mobile surveys and online surveys are now prevalent as companies seek to conduct market research to determine product requirement, or product fit. These surveys include questions on lifestyles, opinions, product/service satisfaction, etc. As market researchers desire to obtain more meaningful and accurate information, large-scale surveys with lengthy questionnaires are routinely employed. However, respondents are often reluctant to participate in surveys with lengthy questionnaires due to a number of factors such as: the considerable investment of time required to complete them, the perceived lack of relevance, the lack of incentive for completion of the questionnaire, and the lack of an immediate return for the respondent. In addition, respondents who may have had a negative experience with other lengthy questionnaires may be reluctant to participate in any future surveys. Also, since all the questions are posed to every single respondent in a survey, there is an increased possibility that some questions will go unanswered by the respondents due respondent fatigue and boredom, resulting in potential loss of information. Low response rates often lead to incomplete and therefore inaccurate surveys, including wasted resources in time and money.

It is an object of the present invention to mitigate or obviate at least one of the above-mentioned disadvantages.

### SUMMARY OF THE INVENTION

In one of its aspects, there is provided a method and system for splitting long questionnaires in a survey into smaller parts; integrating skip logic, if present in the survey; combining the completed split questionnaires and imputing missing data induced by the split questionnaires.

In another of its aspects, there is provided a computing system for transforming at least one large questionnaire into a plurality of split questionnaires, said system comprising:

one or more processors;

memory;

a display, and

one or more programs stored in the memory and configured to be executed by said one or more processors;

a questionnaire database for storing survey pilot data and tracking data associated with said at least one large questionnaire having survey questions;

a data conversion module comprising said one or more programs executable to generate a data matrix associated with said survey pilot data and tracking data, and to convert said data matrix into a continuous data matrix;

a split-questionnaire design (SQD) module comprising said one or more programs executable to receive said continuous data matrix, and operating to transform said at least one large questionnaire into said plurality of split questionnaires, wherein each of said plurality of split questionnaires comprises a subset of said survey questions;

a skip logic module comprising said one or more programs executable to apply conditional logic to the operation of said SQD module when at least one question is based on a respondent's at least one preceding answer to a preceding question;

an imputation module comprising said one or more programs executable to impute missing data induced by said SQD module and to create a complete data set; and

a reporting module comprising said one or more programs executable to present said split questionnaires on said display.

In another of its aspects, there is provided an article of manufacture for system-generated questionnaires, comprising a computer readable recordable medium containing one or more programs which when executed implement the steps of:

receiving a master questionnaire having a plurality of questions;

receiving preliminary survey data, said survey data having at least one of binary and discrete variables;

generating a data matrix having said at least one of binary and discrete variables;

converting said data matrix to a continuous data matrix having latent normal variables associated with said at least one of binary and discrete variables;

determining an optimal split-questionnaire design for dividing said master questionnaire into a plurality of reduced-size questionnaires having at least one block of questions selected from said plurality of questions;

integrating conditional logic with said split-questionnaire design when at least one question from said plurality of questions is based on a respondent's at least one preceding answer to a preceding question; and

generating said plurality of reduced-size questionnaires based on said optimal split-questionnaire design.

In another of its aspects, there is provided an article of manufacture for system-generated survey questionnaires, comprising a computer readable recordable medium containing one or more programs which when executed implement the steps of:

via a user interface, requesting from a data conversion module a type of survey data selected from one of survey pilot data and tracking data, said survey data associated with a large questionnaire having a plurality of survey questions;

at said data conversion module, generating a data matrix associated with said survey pilot data and tracking data, and converting said data matrix into a continuous data matrix;

at a split-questionnaire design (SQD) module, receiving said continuous data matrix and generating a plurality of design matrices (D) comprising a number of questions (Q) and a number of respondents (N); and determining an optimal split-questionnaire design for transforming said large questionnaire into a plurality of split questionnaires with a subset of said survey questions;

at a skip logic module, applying conditional logic to the operation of said SQD module when at least one question is based on a respondent's at least one preceding answer to a preceding question;

at an imputation module, imputing the missing data induced by said SQD module and to create a complete data set;

generating said plurality of reduced-size questionnaires based on said selected split design associated with said minimum KLD; and

at a reporting module, transmitting said generated split questionnaires for presentation on a display.

Advantageously, the methods and systems generate optimal split questionnaires with skip logic for large-scale questionnaires, and address issues with missing data induced by split questionnaires that are served to different and random subsets of respondents. These methods and systems therefore provide an effective tool to reduce respondent burden, boredom, early break-offs, without sacrificing the inferential content of the data. Generally, split-questionnaire designs decrease completion time, fatigue, boredom and non-response and are evaluated more positively by respondents. Optimal-split questionnaires designed using the methods and systems of the present invention facilitate faster, cheaper, and more accurate collection of survey information in massive-scale surveys.

### BRIEF DESCRIPTION OF THE DRAWINGS

Several exemplary embodiments of the present invention will now be described, by way of example only, with reference to the appended drawings in which:

FIG. 1 shows an exemplary computing system;

FIG. 2 shows an exemplary environment in which a method and system for generating optimal split questionnaires operates;

FIG. 3 shows a high level flow diagram illustrating an exemplary process steps for splitting a large survey questionnaire; and

FIG. 4 shows a high level flow diagram illustrating an exemplary process steps for optimal split-questionnaire design in which all the questions are independent of each other;

FIG. 5 shows a histogram with original and imputed binary data, in a first example of skip logic;

FIG. 6 shows a histogram with original and imputed order data, in the first example of skip logic;

FIG. 7 shows an implementation of SQD for each level of a hierarchy, in a second example of skip logic;

FIG. 8 shows a histogram with original and imputed binary data, in a second example of skip logic;

FIG. 9 shows a histogram with original and imputed order data, in the second example of skip logic;

FIG. 10 shows an implementation of SQD for each level of a hierarchy, in a third example of skip logic;

FIG. 11 shows a histogram with original and imputed binary data, in a third example of skip logic;

FIG. 12 shows a histogram with original and imputed order data, in the third example of skip logic;

FIG. 13 shows an implementation of SQD for each level of a hierarchy, in a fourth example of skip logic; and

FIGS. 14a to 14d show exemplary user-interfaces of a computer program product.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

A detailed discussion of the methods and systems surrounding the concepts of generating split questionnaires is provided below. First, a brief introductory description of a basic general purpose system or computing device which can be employed to practice the concepts is illustrated in FIG. 1.

With reference to FIG. 1, an exemplary computing system or general-purpose computing device 10 comprises processing unit (CPU or processor) 12 and system bus 11 that couples various system components including system memory 13 such as read only memory (ROM) 14 and random access memory (RAM) 15 to processor 12. System 10 can include a cache 16 of high speed memory connected directly with, in close proximity to, or integrated as part of processor 12. System 10 copies data from memory 13 and/or storage device 18 to cache 16 for quick access by processor 12. In this way, the cache provides a performance boost that avoids processor 12 delays while waiting for data. These and other modules can control or be configured to control processor 12 to perform various actions. Other system memory 13 may be available for use as well. Memory 13 can include multiple different types of memory with different performance characteristics. It can be appreciated that the methods and system may operate on computing device 10 with more than one processor 12 or on a group or cluster of computing devices networked together to provide greater processing capability. Processor 12 can include any general purpose processor and a hardware module or software module, such as module 1 20a, module 2 20b, and module 3 20c stored in storage device 18, configured to control processor 12 as well as a special-purpose processor where software instructions are incorporated into the actual processor design. Processor 12 may essentially be a completely self-contained computing system, containing multiple cores or processors, a bus, memory controller, cache, etc. A multi-core processor may be symmetric or asymmetric.

System bus 11 may be any of several types of bus structures including a memory bus or memory controller, a peripheral bus, and a local bus using any of a variety of bus architectures. A basic input/output (BIOS) stored in ROM 14 or the like, may provide the basic routine that helps to transfer information between elements within computing device 10, such as during start-up. Computing device 10 further includes storage devices 18 such as a hard disk drive, a magnetic disk drive, an optical disk drive, a solid state drive, a tape drive or the like. Storage device 18 can include software modules 20a, 20b, 20n for controlling processor 12. Other hardware or software modules are contemplated. Storage device 18 is connected to system bus 11 by a drive interface. The drives and the associated computer readable storage media provide non-volatile storage of computer readable instructions, data structures, program modules and other data for computing device 10. In one aspect, a hardware module that performs a particular function includes the software component stored in a non-transitory computer-readable medium in connection with the necessary hardware components, such as processor 12, bus 11, display 22, and so forth, to carry out the function. The basic components are known to those of skill in the art and appropriate variations are contemplated depending on the type of device, such as whether device 10 is a handheld computing device, a desktop computer, or a computer server.

Although the exemplary embodiment described herein employs the hard disk 18, it should be appreciated by those skilled in the art that other types of computer readable media which can store data that are accessible by a computer, such as magnetic cassettes, flash memory cards, digital versatile disks, cartridges, random access memories (RAMs) 15, read only memory (ROM) 14, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 10, input device 24 represents any number of input mechanisms, such as a microphone for speech, a touch-sensitive screen for gesture or graphical input, keyboard, mouse, motion input, speech and so forth. Output device 22 can also be one or more of a number of output mechanisms known to those of skill in the art. In some instances, multimodal systems enable a user to provide multiple types of input to communicate with computing device 10. Communications interface 26 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks, including functional blocks labeled as a “processor” or processor 12. The functions these blocks represent may be provided through the use of either shared or dedicated hardware, including, but not limited to, hardware capable of executing software and hardware, such as processor 12, that is purpose-built to operate as an equivalent to software executing on a general purpose processor. For example, the functions of one or more processors, presented in FIG. 1, may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 14 for storing software performing the operations discussed below, and random access memory (RAM) 15 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 10, shown in FIG. 1, can practice all or part of the recited methods, can be a part of the recited systems, and/or can operate according to instructions in the recited non-transitory computer-readable storage media. Such logical operations can be implemented as modules configured to control processor 12 to perform particular functions according to the programming of the module. For example, FIG. 1 illustrates three modules 20a, 20b and 20n which are modules configured to control processor 12. These modules 20a, 20b and 20n may be stored on storage device 18 and loaded into RAM 15 or memory 13 at runtime or may be stored, as would be known in the art, in other computer-readable memory locations.

Computer system 10 can be of varying types including a workstation, server, computing cluster, blade server, server farm, or any other data processing system or computing device. Due to the ever-changing nature of computers and networks, the description of computer system 10 depicted in FIG. 1 is intended only as a specific example for purposes of illustrating some implementations. Many other configurations of computer system 10 are possible having more or fewer components than the computer system depicted in FIG. 1.

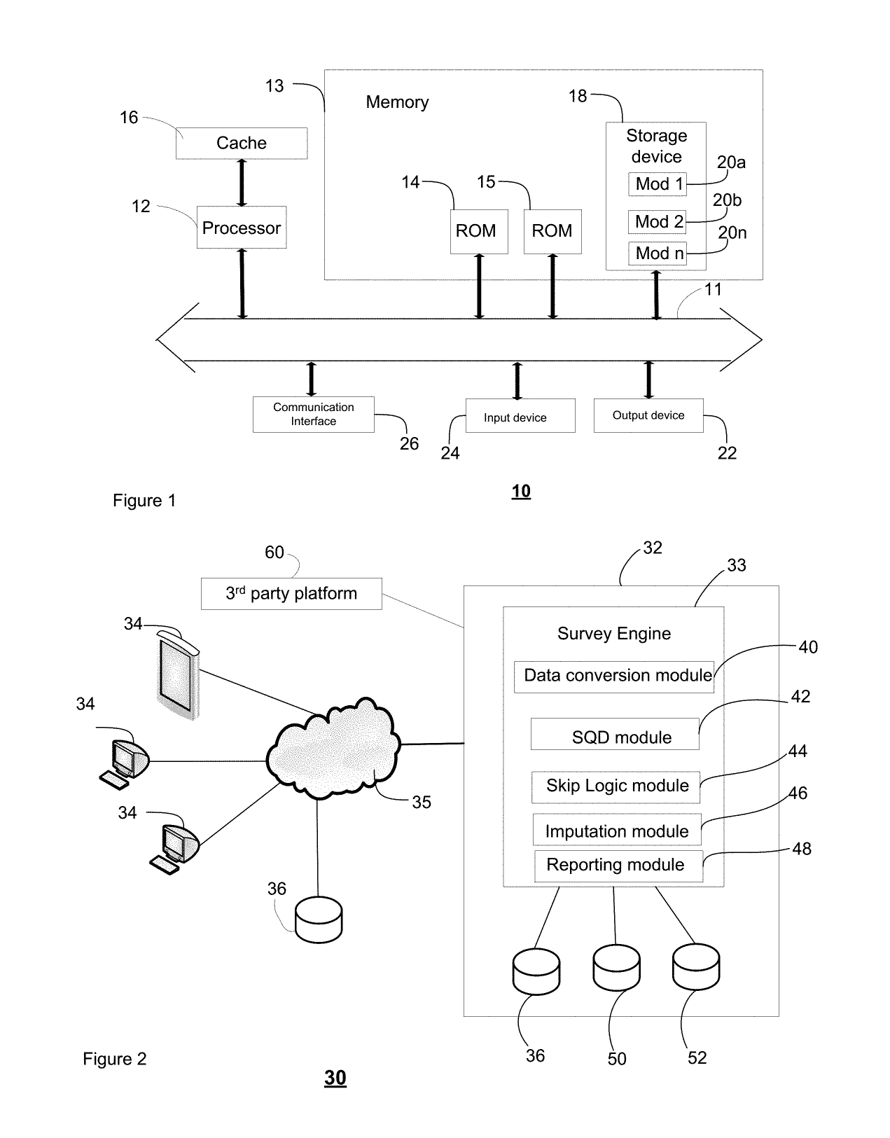

A detailed description of the methods and systems surrounding the concepts of generating split questionnaires will now follow. Several variations shall be discussed herein as the various embodiments are set forth. FIG. 2 shows a top-level component architecture diagram of an exemplary environment, generally identified by reference numeral 30, for which the methods and systems for generating split questionnaires operate. As shown, FIG. 2 illustrates environment 30, in which a user interacts with computing system 32, such as an application server, through user computer 34 communicatively coupled thereto via communication medium 35, or network, e.g., the Internet, and/or any other suitable network. The computers of environment 30 comprise the features of the general-purpose computing device 10, as described above, and may include, but are not limited to: a mini computer, a handheld communication device, e.g. a tablet, a mobile device, a smart phone, a smartwatch, a wearable device, a personal computer, a server computer, a series of server computers, and a mainframe computer.

Application server 32 comprises survey engine 33 for at least receiving large-scale questionnaires from users, analyzing the large questionnaires, converting the large questionnaires into smaller questionnaires, and presenting the smaller questionnaires to the users, and combining the completed split questionnaires and imputing missing data induced by the split questionnaires. Survey engine 33 comprises data conversion module 40, SQD module 42, skip logic module 44, imputation module 46, and reporting module 48. As will be described in greater detail below, data conversion module 40 comprises instructions in data storage 18, executable by processor 12 to cause processor 12 to generate a data matrix associated with survey pilot data and tracking data, and convert the data matrix into a continuous data matrix. Questionnaire database 36 stores the pilot data, tracking data and the large questionnaires, and is coupled to survey engine 33. SQD module 42 receives the continuous data matrix, and SQD module 42 comprises instructions in data storage 18, executable by processor 12 to cause processor 12 to split the large questionnaire into a plurality of small questionnaires with varying subsets of block questions, using at least one of a “between-block” design and a “within-block” design. Skip logic module 44 comprises instructions in data storage 18, executable by processor 12 to cause processor 12 to apply conditional logic to the split-questionnaire design process by SQD module 42, in order to facilitate selection of at least one successive question based on at least one preceding answer by a respondent. As the respondents are asked only the varying subsets of the block questions, this approach is inherently susceptible to information loss by its design. Accordingly, imputation module 46 comprises instructions in data storage 18, executable by processor 12 to cause processor 12 to impute the missing values that result from design to create a complete data set. Reporting module 48 comprises instructions in data storage 18, executable by processor 12 to cause processor 12 to present the generated smaller questionnaires to the user. The generated smaller questionnaires may be stored in reporting database 50, while records of the users, such as user credentials, and so forth, are maintained in user database 52. It should be understood that the survey engine 33 as depicted is merely provided for illustrative purposes and may have more, or less modules and the modules may vary in their functionality or in how the functionality is implemented. One or more of the components and/or one or more additional components of the example environment of FIG. 2 may each include memory for storage of data and software applications, a processor for accessing data and executing applications, and components that facilitate communication over a network. In some implementations, the components may include hardware that shares one or more characteristics with the example computer system that is illustrated in FIG. 1.

It should be noted that although application server 32 has been described as having survey engine 33 with data conversion module 40, SQD module 42, skip logic module 44, imputation module 46, and reporting module 48, and associated databases 36, 50 and 52, user computer 34 may include survey engine 33 with data conversion module 40, SQD module 42, skip logic module 44, imputation module 46, and reporting module 48, and associated databases 36, 50 and 52, to operate as a stand-alone solution. Accordingly, survey engine 33 may be included as an add-on to an existing survey platform to provide the above-noted functionality.

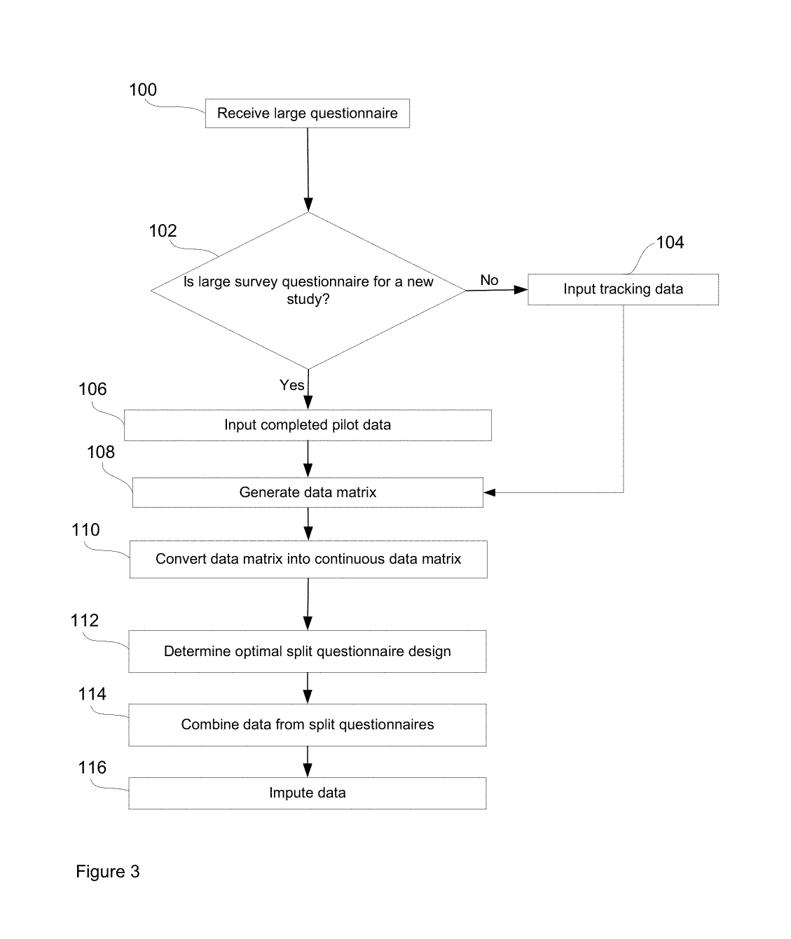

Referring to FIG. 3, an exemplary flowchart of an overview of a method for splitting a large survey questionnaire by optimal SQD engine 33 is shown. The method comprises a plurality of steps, such as, inputting the large survey questionnaire, such as a Confirmit™ XML, questionnaire file by Confirmit, Oslo, Norway (step 100), and determining whether the large survey questionnaire is for a new study or a tracking study (step 102). When the large survey questionnaire corresponds to a new study, then complete pilot data from at least 10% of the total number of respondents is inputted (step 104), otherwise the large survey questionnaire corresponds to a tracking study, in which case tracking data corresponding to responses from a previous wave are inputted (step 106). As used herein, complete pilot data corresponds to having a specified sampling of respondents, that is, at least 10% of the total number of respondents complete all of the survey questions, and all possible answers for all of the questions having been answered at least once. The complete pilot data and tracking data comprises at least one of binary and discrete variables. In steps 108, a data matrix having the at least one of binary and discrete variables is generated, and the data matrix is subsequently converted into a continuous data matrix having latent normal variables associated with the at least one of binary and discrete variables (step 110). For example, questions in the survey questionnaire may include binary type answers (such as, yes or no, e.g. “Do you drink Pepsi™ products?”), or discrete type answers (such as integers, e.g. “Rate our service on a 1 to 5 scale”), and continuous type answers (such as, data with decimal points, e.g. a person's height or weight). In step 112, the optimal split-questionnaire design for dividing said large questionnaire into a plurality of small questionnaires is determined, including the best split for the respondent groups. Data from the completed plurality of small questionnaires is combined (step 114), and missing data is imputed (step 116). As previously described, as the respondents are only presented with different subsets of the block questions from the large questionnaire, there is missing data inherent with such a survey design. Accordingly, the missing data is imputed to create a complete data set by following an iterative algorithm in which every variable with missing values is regressed on all other variables which either are originally complete or contain actual imputations, and may be based on the predictive mean matching.

In another implementation, conditional logic is applied to the split-questionnaire design to facilitate selection of at least one successive question based on at least one preceding answer by a respondent.

In more detail, optimal split-questionnaire design may be generated in two different ways, that is, selecting entire blocks of questions i.e. “between-block” design, or selecting questions in each block, i.e. “within-block” design. In the between-block design, a “split” comprises of the allocation of selected blocks of questions and respondents answer all questions in these blocks. Meanwhile, in the within-block design, a split comprises of sets of selected questions in each of the blocks and respondents answer only those questions in each block. Generally, a block is a subset of the survey questions. For example, if there are 50 questions, then they may be evenly distributed in 10 blocks, each block containing 5 questions. The questions may also be unevenly distributed, which may be accomplished clustering the similar type of questions together. The total number of respondents is split into several groups, and multiple blocks of questions are presented to these groups of respondents. In some instances, all of the blocks of questions are presented to these groups of respondents, however, the best split for the respondent groups may also be determined.

As described above, for the between-block design, entire blocks are selected for the split questionnaire. Referring to the previous example, if a block is selected for a split, all five questions in that block are included therein, and if the block is not selected, all the questions of that block will not be given to the respondent receiving that particular split. Each split includes at least two blocks, so that every respondent is presented with some mixture of different types of questions. This design can also be constrained, where the exact number of blocks i.e. at least two blocks, in each split is specified. In contrast, for within block design the questions are chosen from each block.

In one exemplary implementation, a between-block unconstrained design is implemented with programming languages C++ and R. For example, most of the implementation is C++-based, while the matrix operations are R-based. R language is chosen since it can produce relatively complicated matrix operations in real time, and can be easily embedded within any other software development language. In one example, “Rcpp” and “RInside” packages may be used for embedding R within C++.

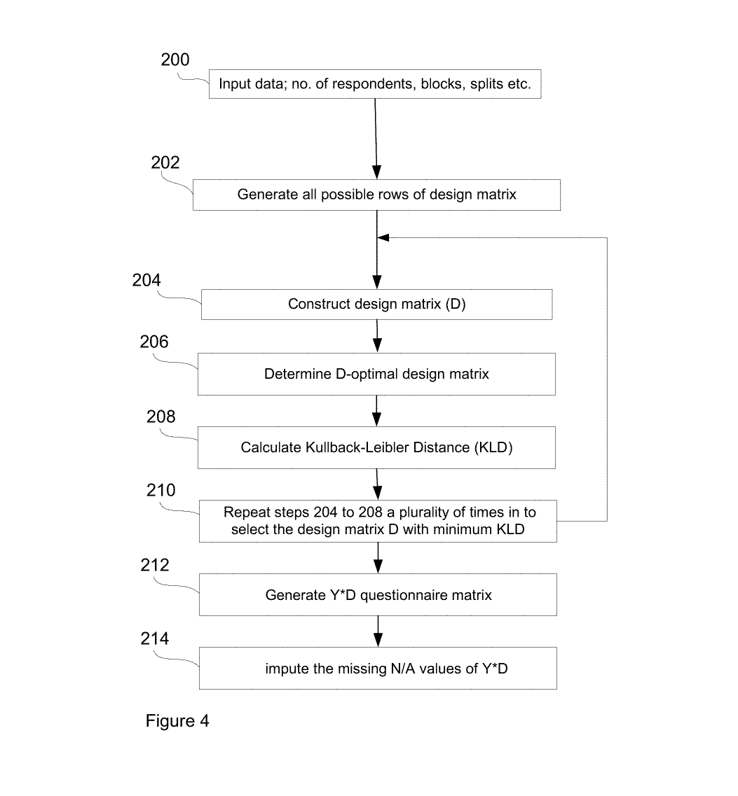

Referring to FIG. 4, there is shown an exemplary flowchart of a method for optimal split-questionnaire design incorporating “between-block” design, which may be carried out by SQD module 42. The method comprises a plurality of exemplary steps comprising a step of inputting data (Y), the number of questions (Q), the number of respondents (N), the number of blocks (B), the number of splits (K), mean estimate (μ), variance-covariance estimate (Σ) (step 200). In this example, the questions are independent of each other. The next step (202) comprises generating all possible rows of the design matrix (2^{B}-1-B rows), followed by randomly selecting K rows to construct design matrix D (step 204). Generally, a design matrix is a binary N×Q matrix D, i.e., each element of the matrix is a 0 or 1, where N corresponds to the number of respondents, Q corresponds to the number of questions. If D_{i,j}=1, then the j^{th} question is presented to the i^{th} respondent, and obviously if D_{i,j}=0, the question is not presented to that respondent. For a between-block design, the matrix can be reduced to a K×B binary matrix, where K corresponds to the number of splits, B corresponds to the number of blocks. In this case, a 0 or 1 denotes whether the block is absent or present in a split, respectively. K splits are randomly chosen from the set of all possible split designs. The cardinality of this set of all possible designs is 2^{B}-1-B, because at least two blocks are chosen for each split, and each chosen design is a row in the design matrix.

Next, step 206 comprises exchanging rows of the design matrix to find D-optimal matrix according to the modified Federov algorithm. The modified Fedorov algorithm helps to achieve a D-optimal pattern (minimum [(D^{T}D)⁻¹]) of the design matrix through row exchanges. This procedure is repeated with a sufficiently high number of randomly selected D matrices to avoid local minima. In one example the number of iterations is limited to 10. Next, the Kullback-Leibler Distance (KLD) is calculated in step 208. Generally, KLD provides a measure of difference between the distribution of the complete data and that of the observed incomplete data after applying the split design matrix. For example, a design is considered optimal when it is at the minimum KL distance among all the designs. Assuming a normal distribution of the data, the mean μ and the covariance matrix Σ is estimated from a pilot survey, and is used to calculate the KLD.

In step 210, steps 204 to 208 are repeated a plurality of times in order to select the design matrix D with minimum KLD. In one example, the number of iterations is preset at 1,000. Next, the input data (Y) and design matrix D are convoluted to generate a Y*D questionnaire matrix (step 212). Y*D includes missing data after applying the design matrix, and * is the operation of element-to-element multiplication of the matrices, otherwise known as convolution. The rows of this matrix contains N/A elements where the corresponding D matrix elements are 0's, and same values as the Y matrix where the corresponding D matrix elements are 1's. Next, a Markov chain Monte Carlo (MCMC) algorithm is applied to impute the missing N/A values of Y*D (step 214) via a plurality of iterations. In one example, the number of iterations is preset at 1,000. The fraction of missing information of the imputed Y*D from the original Y may also be estimated.

In one example, the process steps of the flowchart of FIG. 4 were executed on a simulated data set. The data set comprised responses of 1100 respondents against 49 questions, the first 22 of which were of a binary type, the next 17 were of a discrete type, and the remaining ones were of a continuous type. The responses from the first 100 respondents were considered as the pilot data to estimate μ and Σ. The entire matrix was converted into continuous data, and the optimal between-block design matrix was generated for the remaining 1000×49 matrix (N=1000, Q=49). The questions were distributed in 10 blocks, in which the first 9 blocks had 5 questions each, and the last block had 4 questions. 10 different splits were generated, each of which was given to 100 respondents. The modified Fedorov algorithm was executed 1000 times with different starting matrices to find this design. The optimal design matrix (splits-by-block) with the least KLD is shown in FIG. 5. After the imputation, the fraction of missing information was found to be only 26%.

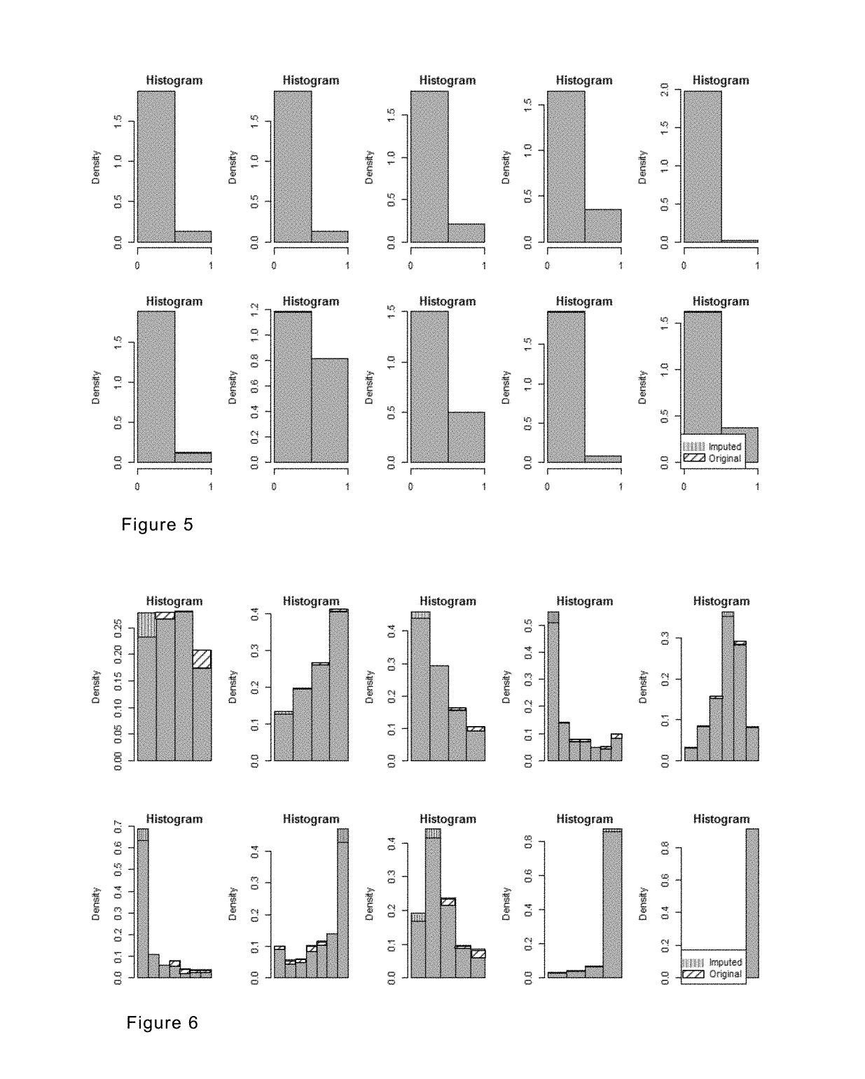

After the promising result on the simulated data, the process steps of the flowchart of FIG. 4 were executed over some real data of 3114 respondents and 125 independent questions. The first 114 responses were used as pilot data, and the rest 3000 for actual SQD. FIGS. 5 and 6 show histograms with a comparison of binary and discrete type responses before and after the MCMC imputation. The top ten questions whose imputed values are closest to the real value were compared. Looking at FIG. 5, the hashed grey area represents the portion of imputed value for each choice of the question and hashed white area represents the portion of real value for each choice of the same question. It can be seen that most of the hashed grey and hashed white areas are overlapped (solid grey area), which indicates that the imputed data represents the real data quite well. Now looking at FIG. 6, it can be seen that there is some discrepancy between real data and imputed data, however, considering the large population size, the total number of observations with different real and imputed value occupies only a minor percentage in the whole data set.

If V(\hat{θ}) is the variance of the original data, and if V(\hat{θ}_{obs}) is the variance of the imputed data set for the split-questionnaire design, then ideally, V(\hat{θ}) should equal to V(\hat{θ}_{obs}) if the imputation perfectly mimics the original data. That means

$$\frac{V ( \hat{θ} )}{V ( {\hat{θ}}_{obs} )} = 1$$

To verify the efficiency of the imputation, the ratio V(\hat{θ})/V(\hat{θ}_{obs}) is compared to 1. If it is close to 1 with a difference of 1, i.e., if V(\hat{θ})/V(\hat{θ}_{obs}) falls into the range of 0 to 2, the imputation is considered efficient and represents the original data well.

The comparison was done with the real data, and since each of the data points is a vector, the V(\hat{θ}) and V(\hat{θ}_{obs}) are the covariance matrices of the original data set and the imputed data set. Thus the ratio is in the form of γ=V(\hat{θ})·V⁻¹(\hat{θ}_{obs}), and the comparison here is the comparison between the eigenvalues of γ and 1.

The eigenvalues calculated from the y matrix are: 2.24 1.84 1.60 1.57 1.49 1.39 1.36 1.31 1.30 1.25 1.22 1.20 1.18 1.17 1.15 1.13 1.11 1.10 1.07 1.07 1.07 1.06 1.03 1.03 1.02 0.99 0.98 0.98 0.96 0.96 0.93 0.92 0.92 0.90 0.90 0.89 0.87 0.86 0.86 0.85 0.84 0.83 0.83 0.82 0.81 0.80 0.79 0.78 0.76 0.76 0.76 0.74 0.73 0.73 0.72 0.72 0.70 0.69 0.69 0.68 0.68 0.67 0.67 0.65 0.65 0.64 0.64 0.63 0.63 0.62 0.61 0.60 0.60 0.59 0.59 0.58 0.57 0.57 0.56 0.56 0.55 0.55 0.54 0.54 0.54 0.53 0.52 0.52 0.51 0.51 0.50 0.50 0.50 0.49 0.49 0.48 0.48 0.47 0.47 0.46 0.45 0.45 0.45 0.44 0.44 0.43 0.43 0.43 0.42 0.42 0.41 0.40 0.40 0.39 0.39 0.38 0.38 0.36 0.36 0.35 0.34 0.34 0.32 0.29 0.23

It can be observed that there is only one out of the 125 values which is greater than 2, and all the other values (99.2%) fall into the interval of 0 and 2, thus indicating that the imputed data is very accurate in representing the original data.

While FIG. 4 shows an exemplary flowchart of a process for optimal split-questionnaire design in which all the questions are independent of each other, when at least one successive question is based on a respondent's at least one preceding answer, then conditional logic, or skip logic, may be applied to split-questionnaire design. For example, an exemplary question for which skip logic may be applied may be: “Which kind of mobile phone OS do you prefer? 1. Android or 2. iOS or 3. None.” If a respondent answers “Android”, then the next question will be related to the Android OS, otherwise it will be related to iOS. There is also the possibility that if the respondent answers “none”, the survey may abort, i.e., all the questions are specific to one of those OS's and if the respondent is familiar to neither, the survey cannot continue. Accordingly, prior art methods have not adequately addressed the challenges associated with integrating skip logic with SQD.

Several challenges associated with integrating skip logic with SQD may be overcome by the methods and systems of the present invention. To illustrate the instances in which skip logic may be applied, in a first example, split-questionnaire design is implemented when there exists a large number of dependent questions corresponding to one skip logic question. For example, a questionnaire may include the following question: “From which of the following companies have you made a purchase of consumer electronics, appliances or entertainment products like music or movies in the past 30 days? Please mark “Retail Store” and/or “Online Website” to indicate where you have made a purchase.” Based on the answer of this question, the respondent may be categorized as a: “purchaser”; “non-purchaser”; “retail purchaser”; or “online purchaser”. The questions that follow are marked to be asked to correspond one of these specific categories. For example, “[ASK IF PURCHASER] Why did you decide to buy your product(s) from [RETAILER]? Please select all that apply.” The label “[ASK IF PURCHASER]” means this question is a dependent of the previous skip logic question. As most of the questionnaire is dependent on the first one, there exists a large number of dependent questions. Accordingly, split-questionnaire design is implemented by applying SQD on the set of dependent questions, as described by the exemplary steps of the flowchart of FIG. 4, and if there are multiple questions on each branch (yes/no) of the skip logic question, each branch may have the same number of questions.

In a second example, split-questionnaire design is implemented when there exists only a few dependent questions i.e. less than two, for a skip logic question. For example, a question on a questionnaire may be:

Q7. How did you choose to receive the product(s) in your order? Please select all that apply.
01 Products shipped to a home or business
02 Products picked up at a store location
03 Products are digital and have been/will be downloaded
   [ASK IF Q7=1]

The next question may be:

Q8a. Have you received the product(s) that were shipped to your home or business yet?
01 Yes
02 No
   [ASK IF Q7 =2]

A follow up question may be:

Q8b. Have you picked up the product(s) at your preferred store location yet?
01 Yes
02 No

It is evident that only Q8a and Q8b are dependent on Q7, and therefore all the dependent questions are included in the questionnaire. As such, in the instance where the questionnaire comprises one skip logic question with a plurality of dependent questions, or a few dependent questions, as illustrated in the first and second examples, the solution of this scenario is to implement SQD at each level.

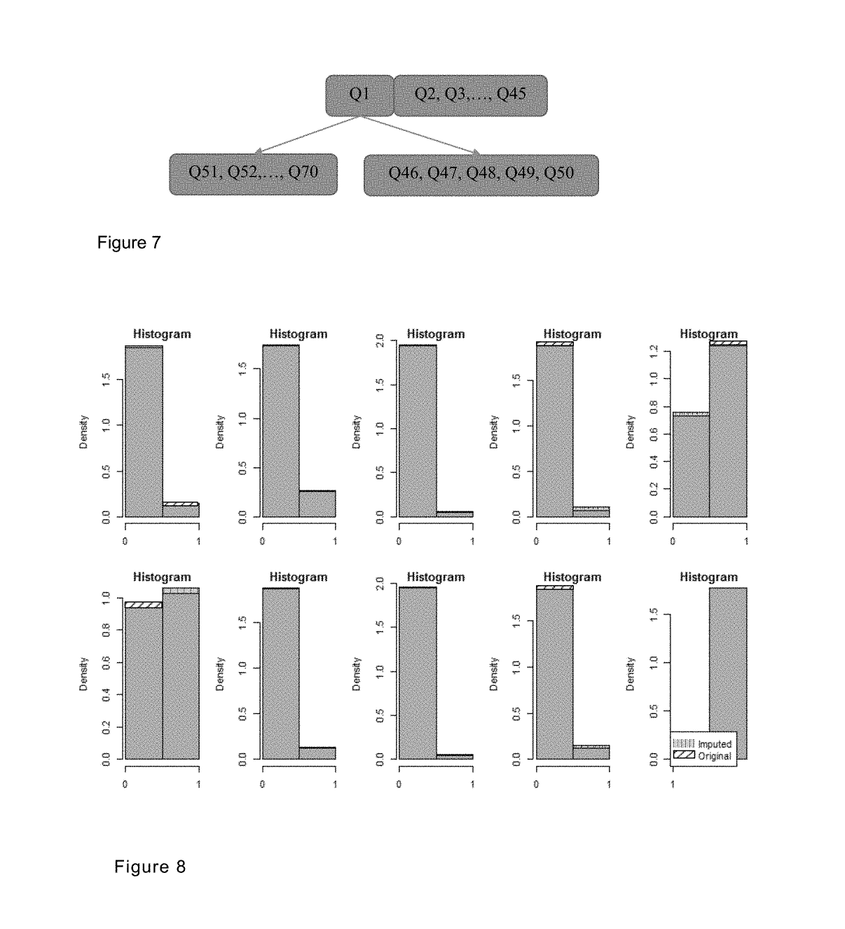

FIG. 7 shows an implementation of SQD for each level of a hierarchy of the questionnaire. Suppose Q1 is a skip logic question, which is independent to Q2 to Q45. Q46-50 are dependent to some answer of Q1 (right branch of Q1), but the number of questions is only 5. If the number of question on a certain level of hierarchy is below or equal to a threshold, SQD is not performed. So in this case, SQD is not performed for Q46-50, and all questions are included in the questionnaire.

For the left branch of Q1, the number of dependent questions is 20, and therefore SQD is necessary. SQD may be executed among different levels of hierarchy by a SQD engine 33 employing a recursive approach having the following exemplary steps:
1. receive input of the number of respondents (N), in which N stays unchanged throughout the process;
2. at the beginning of the SQD( )function (root level), determine the number of skip logic questions that exist at that level;
3. when the number of skip logic questions is 0, proceed to next step 4. If there exists more than one, for each of the questions, call SQD( )function recursively (execute from step 2 for each level);
4. when there are Qd skip logic questions (may be 0), and a maximum of Q questions are allowed in the split questionnaire, then the SQD design matrix D is estimated from the remaining Q-Qd questions; and
5. once D is found, return to the previous level in the hierarchy of the recursive execution. Add Qd columns at the beginning of D. These columns have the skip logic questions uniformly distributed, to form the final D matrix.

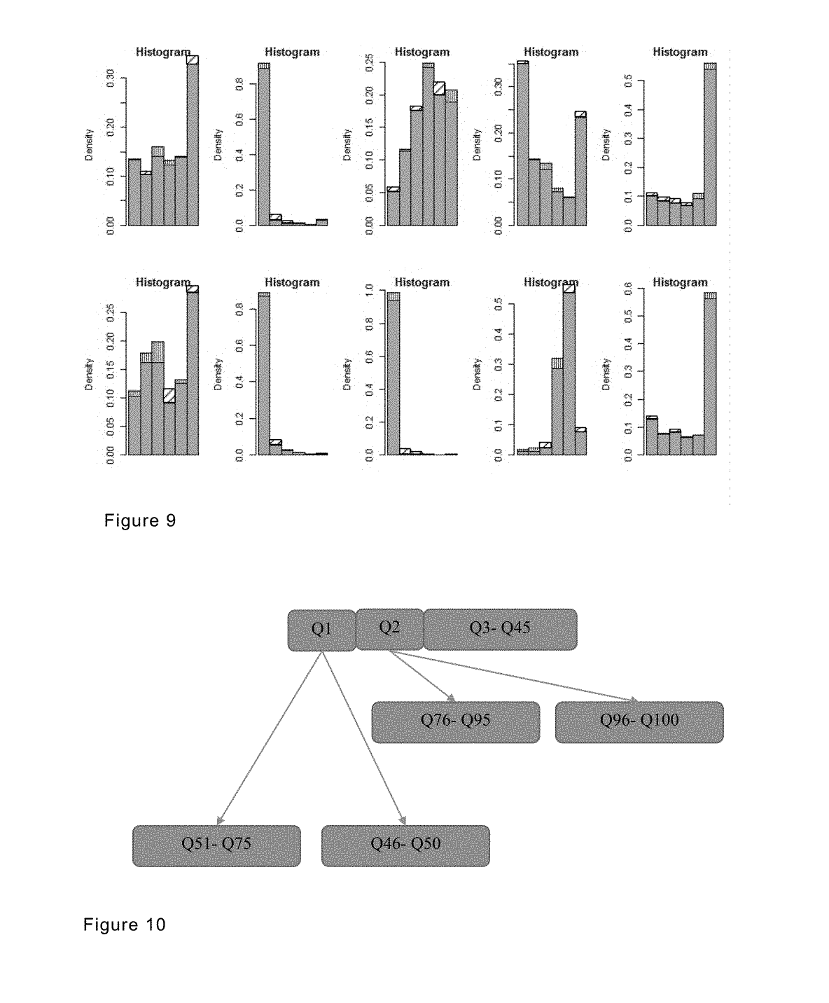

Tests are executed on a questionnaire sample that fit the above scenario, where Qd=1. After performing the split-questionnaire design and imputation, histograms generated for binary and ordered data are shown in FIGS. 8 and 9, in which hashed grey area represents the portion of imputed value for each choice of the question, and hashed white area represents the portion of real value for each choice of the same question, as described above.

In a third example, split-questionnaire design is implemented when there exists more than one skip logic question, and each skip logic question includes a number of dependent questions. For example, in a questionnaire of 36 questions, questions Q6 to 16 depend on Q1, Q31-33 depend on Q32 etc. Q1 and Q32 are independent of each other. Accordingly, in this instance, split-questionnaire design is implemented by (a) isolating the skip logic questions from the questionnaire; (b) if more than one such questions exist, distributing them equally to respondents and (c) applying SQD within the set of dependent questions, as described by the exemplary steps of the flowchart of FIG. 4.

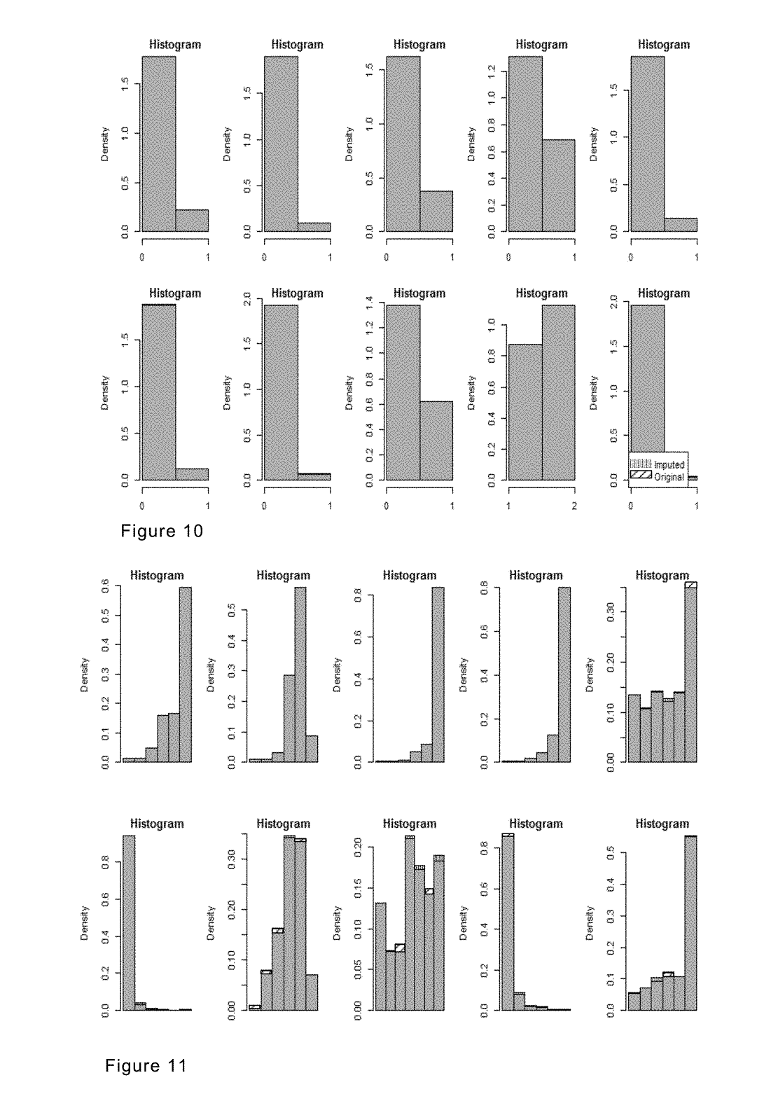

Now referring to FIG. 10, there is shown an implementation of SQD for a questionnaire with multiple skip logic questions. Clearly, Q2 is introduced in this example as a second question to the first level, so Qd=2. As per the guidelines discussed for the previous case, SQD is conducted for the main level, the left branch of Q1, and the left branch of Q2. The comparison histograms after imputation are shown in FIGS. 11 and 12.

In a fourth example, split-questionnaire design is implemented when there exists skip logic within dependent questions. For example Q6-8 depends on the “yes” answer of Q1, and Q10-11 depend on “no”. Again, Q9 depends on Q8, and Q12-16 depend on Q10. So, a tree-like hierarchical structure can be found in the questionnaire.

Accordingly, in this instance, split-questionnaire design is implemented by following the steps provided in the previous example for each level in the hierarchy of the questionnaire.

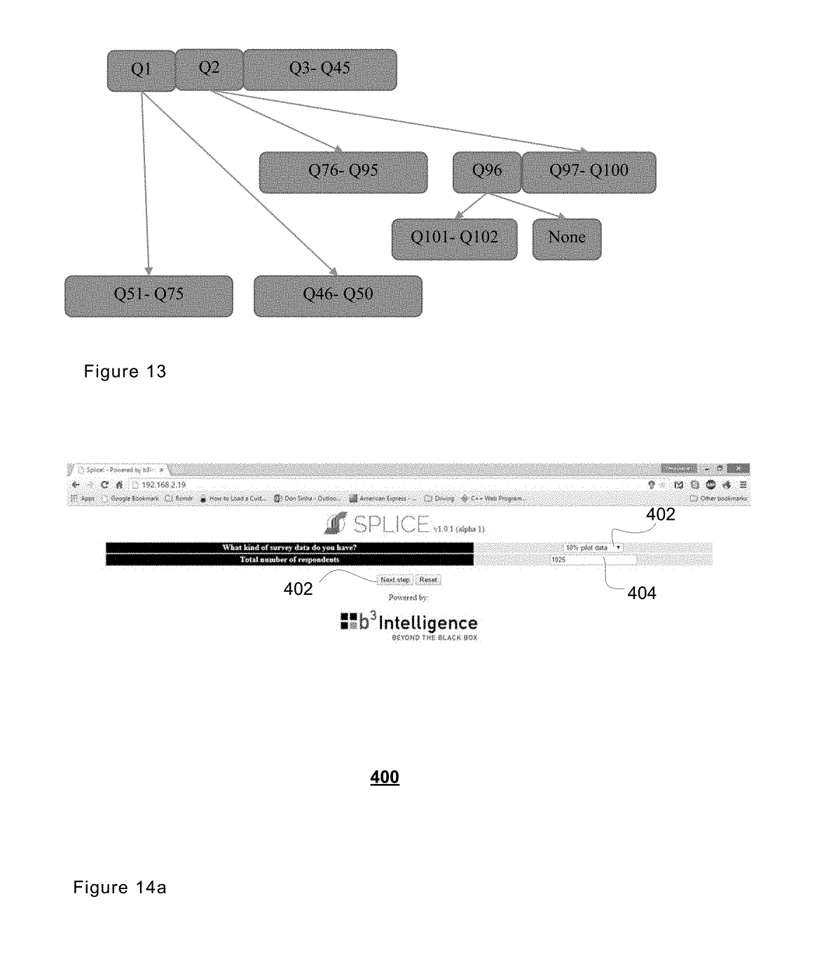

Now referring to FIG. 13, there is shown an implementation of SQD for a questionnaire with multiple skip logic questions. Here, Q96-100 are dependent on Q2 and follows its right branch. Again, Q101-102 follows the left branch of Q96. Accordingly, in this instance, split-questionnaire design is implemented by using the previous recursive routine. The routine processes the lowest level of the hierarchy first, and then gradually the upper levels of the hierarchy until the top of the hierarchy. If there are multiple skip logic questions on any depth, they can be handled using the same approach of the third example.

In a fifth example, split-questionnaire design is implemented when there exists one branch of the skip logic has a “terminate” instruction. An exemplary question may be: “Do you, or anyone else in your household, work in any of the following businesses? Please select all that apply.
Market Research 1 [TERMINATE]
Advertising or Public Relations 2 [TERMINATE]
Consumer Electronics Retailer or Manufacturer 3 [TERMINATE]
Appliance Sales Retailer or Manufacturer 4 [TERMINATE]
Sporting Goods Equipment Retailer or Manufacturer 5
None of the above 6”

Accordingly, in this instance, split-questionnaire design is implemented by complimenting the question with some other skip logic question, which is independent of the first one. However, this type of question is not prevalent in most surveys, and generally such questions occur at the beginning of the questionnaire, and the answer determines whether a person is fit for the survey. These questions are mostly irreplaceable, because surveys depend on them completely, and are part of the “screener” questions which appear before the actual survey questionnaire. As these questions are screeners, generally SQD is not performed on them. SQD is executed on the actual questionnaire as usual, following previous guidelines.

However, there may be a second set of survey questions with a screener question. In this situation, if one respondent chooses the termination branch of the first screener, the second screener will be asked, and if the respondent answers positively, the second survey will continue and SQD will be applied to the second survey as per previous guidelines. If the respondent negatively answers the second screener which leads to termination of the survey, and if there are no more alternative surveys, then the survey ends.

In one particular implementation skip logic and SQD are integrated with each other following the afore-mentioned methods in a computer program product, SPLICE™, from B3 Intelligence Ltd, Toronto, Canada. SPLICE™ may also be integrated with 3rd party platforms 60, such as the ConfirmIt survey platform, such that SPLICE can produce split questionnaires in a ConfirmIt supported format, so that they can be directly uploaded to the server 32 as surveys. ConfirmIt platform provides an interface (API) to program surveys. This platform is available on-demand as Software-as-a-Service (SaaS). Surveys can also be hosted on the ConfirmIt server itself. The survey questionnaires can be made available as XML files, and the survey data as .csv (comma-separated value) files, both of which are easily readable by custom software. XML provides specific tags for the questions, their corresponding answers and the skip logics associated with them. The questions can also be categorized into single, multi (a question that can be viewed as a combination of multiple single questions) or grid questions. The SPLICE computer product can distinguish all three kinds of questions, and find out all logics associated with them.

In addition, the XML files are customizable, i.e., questions and associated logic can be removed from the questionnaire without changing any other information which is readable by ConfirmIt. Additional nodes can also be inserted as script nodes in the XML facilitate insertion of a Look Up Table (LUT), which maps the coded skip logics to actual question numbers. SPLICE can extract and read the LUT and build the skip logic tree as described in the previous examples, and then determine the type of SQD to be applied for the particular questionnaire.

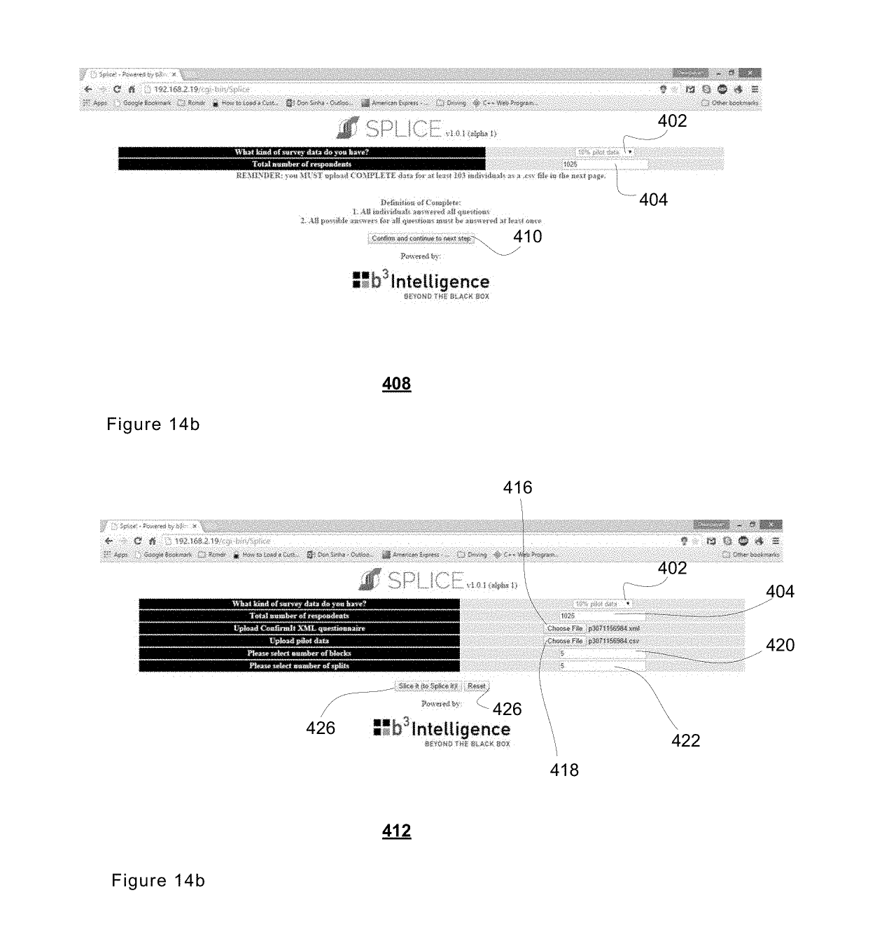

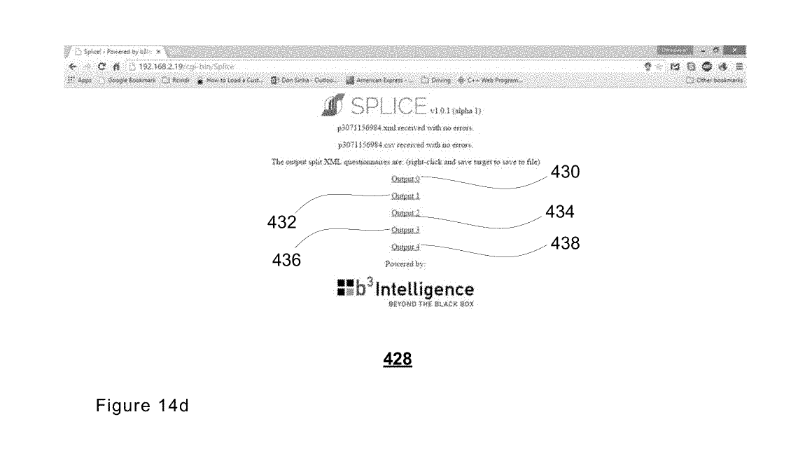

FIG. 14a shows an exemplary user-interface for the SPLICE computer product illustrating a browser welcome page 400 on a display 22 of user computer 34. The interface is designed using HTML5 and CGI C++ so that C++ coded software can be run in the background. Running CGI scripts also allow the software to be integrated with R, where the mathematical operations are executed. As can be seen on the welcome page 400 SQD engine 33 prompts a user to choose a type of survey by presenting an option of a survey with 10% pilot data and a tracking survey, via drop-down selection 402. SQD engine 33 also prompts the user to input the number of respondents (N) in the survey in data input field 404. Following selection of the type of survey and input of the number of respondents, actuation of button 406 advances the user to the next page 408, as shown in FIG. 14b.

Page 408 reminds the user that if the user selection in the previous page was “10% pilot data”, then complete data corresponding to at least 10% of the respondent number inputted in field 404 must be uploaded to the server 32 as a .csv file in the next page 412.” If the choice was “Tracking survey”, then data corresponding to more than 10% of the respondent number inputted in field 404 must be uploaded to the server 32 as a .csv file in the next page 412. A definition of “complete” data is presented for the user, and specifies that all individuals must have answered all of the questions, as well as all possible answers for all questions must have been answered at least once. Actuation of button 410 advances the user to the next page 412, as shown in FIG. 14c.

Page 412 includes a button 416 for selecting a file corresponding to the questionnaire, such as a ConfirmIt XML file, a button 418 for selecting a file corresponding pilot data or tracking data in CSV format, an input field 420 for specifying the number of blocks and an input field 422 for specifying the number splits for the SQD. Button 424 allows the user to reset the input data fields 402, 404, 416, 418, 420 and 424. Actuation of button 426 uploads all data to the server 32, and the data is received by data conversion module 40. Processing of the data by the SQD module 42, skip logic module 44 and imputation module 46 ensues, as described above, and the output split questionnaires are provided in Confirmlt XML format by reporting module 48. The user can download the XML files by clicking on hyperlinks 430, 432, 434, 436, and 438 provided on the next page 428, as shown in FIG. 14d.

One or more of the components and/or one or more additional components of the example environment of FIG. 2 may each include memory for storage of data and software applications, a processor for accessing data and executing applications, and components that facilitate communication over a network. In some implementations, the components may include hardware that shares one or more characteristics with the example computer system that is illustrated in FIG. 1.

In another implementation, databases 36, 50 and 52 may be included in a single database.

Embodiments within the scope of the present disclosure may also include non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner In certain exemplary embodiments, one or more computer systems (e.g., a standalone, user, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computing system for transforming at least one large questionnaire into a plurality of split questionnaires, said system comprising:
one or more processors;
memory;
a display, and
one or more programs stored in the memory and configured to be executed by said one or more processors;
a questionnaire database for storing survey pilot data and tracking data associated with said at least one large questionnaire having survey questions;
a data conversion module comprising said one or more programs executable to generate a data matrix associated with said survey pilot data and tracking data, and to convert said data matrix into a continuous data matrix;
a split-questionnaire design (SQD) module comprising said one or more programs executable to receive said continuous data matrix, and operating to transform said at least one large questionnaire into said plurality of split questionnaires, wherein each of said plurality of split questionnaires comprises a subset of said survey questions;
a skip logic module comprising said one or more programs executable to apply conditional logic to the operation of said SQD module when at least one question is based on a respondent's at least one preceding answer to a preceding question;
an imputation module comprising said one or more programs executable to impute missing data induced by said SQD module and to create a complete data set; and
a reporting module comprising said one or more programs executable to present said split questionnaires on said display.

2. The computing system of claim 1, wherein said at least one of said plurality of split questionnaires comprises questions selected from multiple blocks of said survey questions, wherein each of said blocks comprises a subset of said survey questions.

3. The computing system of claim 1, wherein said at least one of said plurality of split questionnaires comprises questions selected from one block of said survey questions, wherein said block comprises a subset of said survey questions.

4. The computing system of claim 2, wherein said SQD module comprises said one or more programs executable by said one or more processors to determine an optimal split-questionnaire design having questions selected from multiple blocks of said survey questions.

5. The computing system of claim 4, wherein said SQD module receives survey data (Y) comprising at least one of a number of questions (Q), a number of respondents (N).

6. The computing system of claim 5, wherein said SQD module's said one or more programs are executed by said one or more processors to perform operations comprising:
generating a plurality of design matrices (D) comprising said number of questions (Q) and said number of respondents (N);
generating a list of possible splits (K);
randomly selecting a desired number of splits;
determining a number of blocks (B), a number of splits (K), a mean estimate (μ), and a variance-covariance estimate (Σ);
recursively performing an operation on said plurality of design matrices (D) using a modified Fedorov algorithm to find said optimal split-questionnaire design to avoid local minima;
calculating a Kullback-Leibler distance (KLD) for each split design; and
selecting a split design associated with a minimum KLD.

7. The computing system of claim 6, wherein said imputation module imputes missing responses for said blocks that are missing for each of said respondents; and computes the amount of missing information to estimate the optimal quality of said split questionnaire.

8. The computing system of claim 7, comprising a further step of applying said selected split design associated with said minimum KLD to generate said plurality of split questionnaires.

9. The computing system of claim 8, wherein said skip logic module comprises said one or more programs executable by said one or more processors to perform operations on said at least one large questionnaire having a skip logic question (Qd) at a first level, said skip logic question having dependent questions at subsequent levels in a hierarchy; wherein said one or more programs are executable to perform operations comprising:
receiving the number of respondents (N);
executing said one or more programs at said SQD module at said first level, and determining the number of skip logic questions (Qd) at said first level; and
if the number of skip logic questions (Qd) is 0 and a maximum of Q questions are allowed in said split questionnaire, then a SQD design matrix (D) is estimated from the remaining Q-Qd questions; otherwise if there is at least one skip logic question (Qd), then for each of said at least one skip logic questions (Qd), executing said one or more programs at SQD module recursively at each subsequent level to find said SQD design matrix (D); and returning to the previous level in said hierarchy of said recursive execution, adding Qd columns at the beginning of said SQD design matrix (D) to form a final SQD design matrix (D) with said columns having said skip logic questions uniformly distributed; thereby integrating conditional logic with said split-questionnaire design.

10. The computing system of claim 8, wherein said skip logic module comprises said one or more programs executable by said one or more processors to perform operations on said at least one large questionnaire having a first skip logic question (Qd) and a second skip logic question (Qd) at a first level, each of said skip logic questions having dependent questions at subsequent levels in a hierarchy; wherein said one or more programs are executed to perform operations comprising:
receiving the number of respondents (N);
isolating said skip logic questions from said at least one large questionnaire and distribute them equally to said respondents;
executing said one or more programs at said SQD module at said first level for each of said skip logic questions recursively at each subsequent level to find said SQD design matrix (D); and returning to the previous level in said hierarchy of said recursive execution, adding Qd columns at the beginning of said SQD design matrix (D) to form a final SQD design matrix (D) matrix with said columns having said skip logic questions uniformly distributed; thereby integrating conditional logic with said split-questionnaire design.

11. The computing system of claim 8, wherein said skip logic module comprises said one or more programs executable by said one or more processors to perform operations on said at least one large questionnaire having a first skip logic question (Qd), a second skip logic question (Qd) at a first level, and third skip logic question (Qd) at a second level, and each of said skip logic questions having dependent questions at subsequent levels in a hierarchy; wherein said one or more programs are executable by said one or more processors to perform operations comprising:
receiving the number of respondents (N);
isolating said skip logic questions from said at least one large questionnaire and distribute them equally to said respondents; and
executing said one or more programs at said SQD module at each of said levels for each of said skip logic question recursively and at each subsequent level to find said SQD design matrix (D); and returning to the previous level in said hierarchy of said recursive execution, adding Qd columns at the beginning of said SQD design matrix (D) to form a final SQD design matrix (D) matrix with said columns having said skip logic questions uniformly distributed; and
thereby integrating conditional logic with said split-questionnaire design.

12. The computing system of claim 9, wherein said number of questions (Q) are independent of each other.

13. The computing system of claim 10, wherein said number of questions (Q) are independent of each other.

14. The computing system of claim 11, wherein said number of questions (Q) are independent of each other.

15. An article of manufacture for system-generated questionnaires, comprising a computer readable recordable medium containing one or more programs which when executed implement the steps of:
receiving a master questionnaire having a plurality of questions;
receiving preliminary survey data, said survey data having at least one of binary and discrete variables;
generating a data matrix having said at least one of binary and discrete variables;
converting said data matrix to a continuous data matrix having latent normal variables associated with said at least one of binary and discrete variables;
determining an optimal split-questionnaire design for dividing said master questionnaire into a plurality of reduced-size questionnaires having at least one block of questions selected from said plurality of questions;
integrating conditional logic with said split-questionnaire design when at least one question from said plurality of questions is based on a respondent's at least one preceding answer to a preceding question; and
generating said plurality of reduced-size questionnaires based on said optimal split-questionnaire design.

16. The article of manufacture of claim 15, wherein said optimal split-questionnaire design is determined by the steps of:
receiving survey data (Y) comprising at least one of a number of questions (Q), a number of respondents (N);
generating a plurality of design matrices (D) comprising said number of questions (Q) and number of respondents (N);
generating a list of possible splits (K);
randomly selecting a desired number of splits;
determining a number of blocks (B), a number of splits (K), a mean estimate (μ), and a variance-covariance estimate (Σ);
recursively performing an operation on said plurality of design matrices (D) using a modified Fedorov algorithm to find said optimal split-questionnaire design to avoid local minima;
calculating a Kullback-Leibler distance (KLD) for each split design; and
selecting a split design associated with a minimum KLD.

17. The article of manufacture of claim 16, comprising a further step of generating said plurality of reduced-size questionnaires based on said selected split design associated with said minimum KLD.

18. An article of manufacture for system-generated survey questionnaires, comprising a computer readable recordable medium containing one or more programs which when executed implement the steps of:
via a user interface, requesting from a data conversion module a type of survey data selected from one of survey pilot data and tracking data, said survey data associated with a large questionnaire having a plurality of survey questions;
at said data conversion module, generating a data matrix associated with said survey pilot data and tracking data, and converting said data matrix into a continuous data matrix;
at a split-questionnaire design (SQD) module, receiving said continuous data matrix and generating a plurality of design matrices (D) comprising a number of questions (Q) and a number of respondents (N); and determining an optimal split-questionnaire design for transforming said large questionnaire into a plurality of split questionnaires with a subset of said survey questions;
at a skip logic module, applying conditional logic to the operation of said SQD module when at least one question is based on a respondent's at least one preceding answer to a preceding question;
at an imputation module, imputing the missing data induced by said SQD module and to create a complete data set;
generating said plurality of reduced-size questionnaires based on said selected split design associated with said minimum KLD; and
at a reporting module transmitting said generated split questionnaires for presentation on a display.

19. The article of manufacture of claim 18, wherein said conditional logic is applied to said large questionnaire when a skip logic question (Qd) is present at one level and said skip logic question (Qd) has dependent questions at subsequent levels in a hierarchy; wherein said one or more programs are executed to perform operations comprising:
receiving the number of respondents (N);
at said split-questionnaire design (SQD) module, executing said one or more programs executable to receive said continuous data matrix at said one level, and determining the number of skip logic questions (Qd) at said first level; and
for each of said at least one skip logic questions (Qd), executing said SQD module executing one or more programs recursively at each subsequent level to find D;
and returning to the previous level in said hierarchy of said recursive execution, adding Qd columns at the beginning of D to form a final D matrix with said columns having said skip logic questions uniformly distributed; thereby integrating conditional logic with said split-questionnaire design.

20. The article of manufacture of claim 19, wherein said number of questions (Q) are independent of each other.
